(19) United States
(12) Patent Application Publication
(10) Pub. No.: US 2026/0057725 A1
(43) Pub. Date: Feb. 26, 2026

(54) MEDIUM PROCESSING SYSTEM, MEDIUM PROCESSING METHOD, AND NON-TRANSITORY COMPUTER-READABLE STORAGE MEDIUM

(71) Applicant: GLORY LTD., Himeji-shi (JP)

(72) Inventors: Yasushi Kimura, Hyogo (JP); Junji Mashimo, Hyogo (JP)

(21) Appl. No.: 19/325,578

(22) Filed: Sep. 11, 2025

Related U.S. Application Data
(63) Continuation of application No. PCT/JP2024/009486, filed on Mar. 12, 2024.

(30) Foreign Application Priority Data
Mar. 17, 2023 (JP) 2023-042740

(51) Int. Cl. G07D 11/20; G07D 11/00; G07D 11/60

(52) U.S. Cl. CPC G07D 11/20; G07D 11/0093; G07D 11/60; G07D 2211/00

(57) ABSTRACT

Provided are a medium processing system, a medium processing method, and a medium processing program with which it is possible to easily perform processing when reject medium return processing has occurred. The medium processing system includes: a medium processing device that receives a valuable medium; a slip processing device that receives a deposit slip; and a control circuitry that returns the deposit slip from the slip processing device when return processing for returning a reject medium, which is a valuable medium that cannot be deposited in the medium processing device, has occurred.

### CROSS-REFERENCE TO RELATED APPLICATIONS

The present application is a Continuation application of PCT Application No. PCT/JP2024/009486 filed on Mar. 12, 2024, which claims priority to Japanese Patent Application No. 2023-042740 filed on Mar. 17, 2023, under the Paris Convention and provisions of national law in a designated State. The entire contents of the applications are hereby incorporated by reference.

### TECHNICAL FIELD

The present disclosure relates to a medium processing system, a medium processing method, and a non-transitory computer-readable storage medium.

### BACKGROUND ART

In the related art, sales proceeds from a store are deposited by a user, such as a retail store clerk, into a medium processing system that performs various transactions involving valuable media such as currency. In this case, first, a deposit slip is inserted by the user into the medium processing system. This causes the medium processing system to start the deposit process. Next, the valuable media to be deposited are inserted to the medium processing system by the user.

In the deposit process, the medium processing system may determine that the inserted valuable medium is not depositable in some situations. In this case, the medium processing system returns the non-depositable valuable medium to the user as a rejected medium.

### SUMMARY

A medium processing system of the present disclosure comprises: a medium processing device that receives a valuable medium inserted by a user in a deposit transaction; a slip processing device that receives a deposit slip inserted by the user; and a control circuitry that causes the slip processing device to return the deposit slip when a return process of returning a rejected medium occurs, the rejected medium being a valuable medium that is not depositable in the medium processing device.

### BRIEF DESCRIPTION OF DRAWINGS

FIG. 1 is a diagram illustrating an example of an external appearance of a medium processing system according to the present embodiment as viewed from the front side;

FIG. 2 is a diagram illustrating an example of an external appearance of the medium processing system as viewed from the rear side;

FIG. 3 is a diagram schematically illustrating an example of an internal structure of a slip processing device;

FIG. 4 is a diagram schematically illustrating an example of an internal structure of a drop box;

FIG. 5 is a block diagram illustrating an example of a functional block of the medium processing system;

FIG. 6 is a diagram illustrating an example of a hardware configuration of the medium processing system serving as a computer;

FIG. 7 is a flowchart illustrating an example of a procedure of a deposit transaction performed by the medium processing system when reject occurs;

FIG. 8 is a schematic view for describing an identification screen;

FIG. 9 is a schematic view for describing a transport path when a deposit slip is stored in a temporary storage unit;

FIG. 10 is a schematic view for describing a transport path when a deposit slip is stored in the storage unit; and

FIG. 11 is a schematic view for describing a transport path when a deposit slip is returned.

### DESCRIPTION OF EMBODIMENTS

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. The processor may be a programmed processor which executes a program stored in a memory.

In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor which may be considered a type of circuitry, the circuitry, means, or units are a combination of hardware and software, the software being used to configure the hardware and/or processor.

An object of the present disclosure is to provide a medium processing system, a medium processing method, and a non-transitory computer-readable storage medium that can easily perform a process for handling a case where a rejected medium is generated.

A medium processing system of the present disclosure comprises: a medium processing device that receives a valuable medium inserted by a user in a deposit transaction; a slip processing device that receives a deposit slip inserted by the user; and a control circuitry that causes the slip processing device to return the deposit slip when a return process of returning a rejected medium occurs, the rejected medium being a valuable medium that is not depositable in the medium processing device.

A medium processing method of the present disclosure comprises: receiving a deposit slip inserted by a user in a deposit transaction; receiving a valuable medium inserted by the user; and returning the deposit slip when a return process of returning a rejected medium occurs, the rejected medium being a valuable medium that is not depositable.

A non-transitory computer-readable storage medium of the present disclosure comprising executable instructions; wherein the executable instructions when executed by a processor from the non-transitory computer-readable storage medium cause the processor to perform operations comprises: receiving a deposit slip inserted by a user in a deposit transaction; receiving a valuable medium inserted by the user; and returning the deposit slip when a return process of returning a rejected medium occurs, the rejected medium being a valuable medium that is not depositable.

It should be noted that the above-described solution may include one or more of the following features in any combination that is consistent and reasonable.

The medium processing device may comprise one or more devices selected from a rolled coin device, a banknote device, a loose coin device, and a check processing device. The slip processing device may also serve as a check processing device for processing checks.

The above-mentioned solution may further comprise a drop box to which the deposit slip and the rejected medium that are returned are inserted in a paired manner. An envelope containing both the returned deposit slip and rejected medium may be inserted to the drop box. In this manner, the deposit slip provided with the recognition information is inserted together with the rejected medium, and thus the deposit process of the rejected medium can be easily performed.

In the above-mentioned solution, the user may be caused to select an input regarding whether to deposit the rejected medium using the drop box when the return process occurs. As a result, the user can select how to handle the rejected medium, such as whether to take it back or deposit it.

In the above-mentioned solution, when an input to deposit the rejected medium using the drop box is selected, an instruction to insert the deposit slip and the rejected medium to the drop box may be notified to the user. In this manner, it is possible to prevent the user from forgetting to deposit the rejected medium. The notification may be voice output or display. Alternatively, the notification may be an output of a signal to the device owned by the user.

In the above-mentioned solution, the display unit may display an indication to induce insertion of the deposit slip and the rejected medium to the drop box. In this manner, the user can be reliably instructed to deposit the rejected medium.

In the above-mentioned solution, the drop box may comprise: a receiving port that receives the deposit slip and the rejected medium; and a shutter disposed at the receiving port. As a result, it is possible to prevent items from being mistakenly inserted to the drop box.

In the above-mentioned solution, a lock that limits the opening of the shutter may be provided. The shutter is unlocked when the input to deposit the rejected medium using the drop box is received. As a result, it is possible to prevent items from being mistakenly inserted to the drop box.

In the above-mentioned solution, the drop box may comprise an insertion sensor that detects insertion of the deposit slip and the rejected medium. In this manner, when the rejected medium is deposited, the insertion to the drop box can be reliably detected. The insertion sensor may be an image sensor that reads at least one of the size, shape, color, written letters, and diagram of the inserted medium. The control unit specifies the type of the inserted medium on the basis of the information read by the insertion sensor. The control unit determines that the medium of the specified type has been inserted. The insertion sensor may be an optical sensor that detects the passage of objects. The control unit determines that a certain kind of object has been inserted on the basis of detection of the passage of an object with an optical sensor during a time period in which the insertion of an object of that type is expected. For example, the control unit determines that a rejected medium has been inserted on the basis of detection of the passage of an object with an optical sensor during a time period in which the insertion of the rejected medium is expected.

In the above-mentioned solution, when the deposit slip and the rejected medium are not inserted to the drop box, the control unit may notify that the deposit slip and the rejected medium are not inserted based on a signal of the insertion sensor. In this manner, it is possible to prevent the deposit of the rejected medium from being forgotten.

In the above-mentioned solution, the slip processing device may comprise a removal sensor that detects removal of the deposit slip that is returned when the return process occurs. The removal sensor may be an optical sensor that detects the presence/absence of the deposit slip. When omission of removal of the deposit slip is detected, it is possible to notify that the deposit slip corresponding to the rejected medium has not been inserted to the drop box. It is possible to notify that the deposit slip corresponding to the rejected medium has not been inserted to drop box when the insertion sensor of the drop box detects insertion of a rejected medium to the drop box, and the removal sensor detects omission of removal of the deposit slip. In this manner, the administrator is notified that an envelope without the deposit slip has been inserted to the drop box, thereby enabling a prompt response to the deposit process of the rejected medium.

In the above-mentioned solution, the slip processing device may comprise a recognition unit that recognizes the first information that is added to the deposit slip and specifies the user or an account related to the user, or the deposit transaction. Further, it is possible to start the process of receiving the valuable medium by the medium processing device when the first information is normally recognized by the recognition unit. In this manner, the deposit transaction of the valuable medium can be reliably performed on the basis of the information added to the deposit slip.

In the above-mentioned solution, when the return process occurs, at least one of a type and a number of rejected media may be notified. In this manner, information about the occurrence of the return process and the rejected medium can be notified to the user. In the above-mentioned solution, when the return process occurs, the user may be caused to input information regarding the type and the number of rejected media, or a total amount of rejected media. In this manner, notification of information on the rejected medium determined by the user can be provided to the administrator of the medium processing system or medium processing system.

In the above-mentioned solution, when the return process occurs, the user may be caused to input information regarding the type and the number of rejected media, or a total amount of rejected media. The second information may be information representing the date and time of the return process. The second information may be information related to the type and the number of rejected media or the total amount of rejected media. The second information may be printed on the deposit slip. In this manner, it becomes clear that the returned deposit slip has been returned due to the occurrence of the return process.

In the above-mentioned solution, the slip processing device may comprise a temporary storage unit that temporarily stores the deposit slip received. In this manner, in the return process, only the deposit slip to be returned can be reliably returned.

In the above-mentioned solution, the slip processing device may comprise a storage unit that stores the deposit slip stored in the temporary storage unit when the return process does not occur. In this manner, deposit slips for completed deposit transactions and deposit slips for incomplete deposit transactions can be handled separately.

In the above-mentioned solution, the slip processing device may comprise a return port for returning the deposit slip stored in the temporary storage unit when the return process occurs. In this manner, the rejected medium can be deposited using the returned deposit slip. A removal sensor may be provided in the vicinity of the return port.

### Configuration of Medium Processing System 100

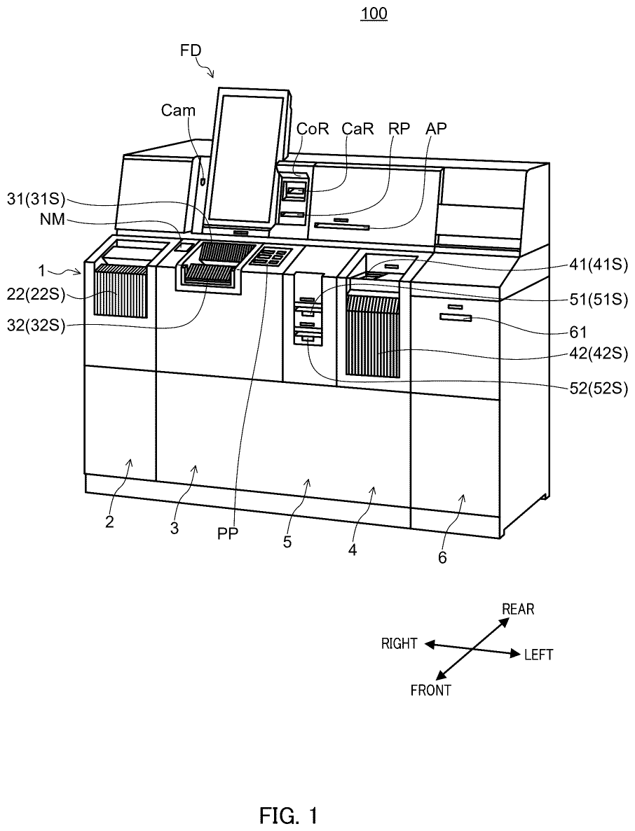

FIG. 1 is a diagram illustrating an example of an external appearance of a medium processing system 100 according to the present embodiment as viewed from the front side. Note that, FIG. 1 illustrates the front-rear and left-right directions with reference to the medium processing system 100, and the description herein is based on these directions.

The medium processing system 100 is installed in various facilities comprising financial institution branches (financial branches) such as banks, or retail stores (distribution stores) such as convenience stores. The medium processing system 100 is a device that performs various processes related to transactions involving various types of valuable medium.

Specific examples of the valuable medium include banknotes, coins, and checks (cheques). The coins include rolled coins and loose coins. The banknotes include bound notes and loose notes. Specific examples of the transaction include deposit, dispense, money change, fund transfer and the like.

The medium processing system 100 comprises a rolled coin device 2 that performs a process related to transactions involving rolled coins, a banknote device 3 that performs a process related to transactions involving loose notes, a loose coin device 4 that performs a process related to transactions involving loose coins, a slip processing device 5 that performs a process related to deposit slips, and a drop box 6 into which an envelope containing a rejected medium, which is a valuable medium determined by the medium processing system 100 to be not depositable, is inserted. The slip processing device 5 is used also as a check processing device that performs a process related to transactions involving checks. In the following description, the devices that receive valuable mediums, such as the rolled coin device 2, the banknote device 3, the loose coin device 4, and the slip processing device 5, may be collectively referred to as “medium processing device”. The rejected medium is a medium that could not be normally recognized by the medium processing device, for example. In addition, the rejected medium may be a medium that has been recognized by the medium processing device as being suspected of being counterfeit. In addition, the rejected medium may be a medium that could not be stored inside the medium processing device.

The rolled coin device 2, the banknote device 3, the loose coin device 4, the slip processing device 5, and the drop box 6 are stored in a housing 1 in the state where they are disposed side by side along the left-right direction.

In the example illustrated in FIG. 1, as viewed with reference to the medium processing system 100, the rolled coin device 2, the banknote device 3, the slip processing device 5, the loose coin device 4, and the drop box 6 are disposed in this order from the right side to the left side. Further, a bound note device that performs a process related to transactions involving bound notes may be disposed. The bound note device may be disposed between the rolled coin device 2 and the banknote device 3.

In the front surface of the housing 1, at least one of the inlet and outlet of each device is provided. The rolled coin device 2 comprises an outlet 22 for dispensing rolled coin. The outlet 22 is provided with a shutter 22S for opening and closing the outlet 22.

The banknote device 3 comprises an inlet 31 for receiving banknotes and an outlet 32 for dispensing banknotes. The inlet 31 is provided with a shutter 31S for opening and closing the inlet 31, and the outlet 32 is provided with a shutter 32S for opening and closing the outlet 32.

The loose coin device 4 comprises an inlet 41 for receiving loose coins and an outlet 42 for dispensing loose coins. The inlet 41 is provided with a shutter 41S for opening and closing the inlet 41, and the outlet 42 is provided with a shutter 42S for opening and closing the outlet 42.

The slip processing device 5 comprises a receiving port 51 for receiving deposit slips or checks, and a return port 52 for feeding deposit slips or checks. The receiving port 51 is provided with a shutter 51S for opening and closing the receiving port 51, and the return port 52 is provided with a shutter 52S for opening and closing the return port 52.

Note that, while FIG. 1 illustrates an example in which each inlet and each outlet are provided with a shutter, each inlet or each outlet may not be provided with a shutter in the present disclosure.

In addition, the drop box 6 comprises a receiving port 61 for receiving the insertion of an envelope containing a rejected medium. The receiving port 61 may be provided with a shutter with a lock. In the case where the drop box 6 is provided with a shutter, the lock may be configured to be unlocked when the insertion of a rejected medium is selected by the user in a deposit process described later.

A front display FD and a pin pad PP are provided as a user interface of the medium processing system 100 in the front surface of the housing 1.

The front display FD is a display unit, and also an input unit. The front display FD has a structure (touch panel) in which a touch pad and a flat-screen display are superimposed, performs various kinds of display for the user, and receives input operation of the user.

The pin pad PP receives input of a personal identification number (PIN) by the user. The pin pad PP is numeric keys, for example. Note that, the term “user” refers to a person who conducts a transaction using the medium processing system 100, and is, for example, a customer utilizing a facility in which the medium processing system 100 is installed.

In the example illustrated in FIG. 1, the front display FD and the pin pad PP are disposed at positions corresponding to the banknote device 3 in the horizontal direction.

For example, the front display FD is provided on the upper side of the banknote device 3, and the pin pad PP is provided adjacent to the inlet 31 or the outlet 32 of the banknote device 3. The front display FD and the pin pad PP are provided at positions when they are easily operable by the user using the banknote device 3.

In addition, a card reader CaR, a code reader CoR, a receipt printer RP, an A4 printer AP, a camera Cam, and an near field communication (NFC) reader NM are provided in the front surface of the housing 1.

The card reader CaR reads, for example, cash cards for bank accounts or credit cards. The code reader CoR reads barcodes, two-dimensional codes, and the like.

The receipt printer RP and the A4 printer AP print and provide the user with information related to the result of the processing performed by the user using the medium processing system 100.

The camera Cam captures the face or the like of the user using the medium processing system 100 and the administrator of the medium processing system 100, and uses it as a part of the history information of the process. In addition, the camera Cam may be used for generating face image data used for facial identification of the user and administrator.

The administrator of the medium processing system 100 is a person who manages the medium processing system 100 and valuable medium, and is a person employed in the facility in which the medium processing system 100 is installed, for example.

The NFC reader NM communicates with a mobile terminal (such as a smartphone or a tablet terminal) owned by the user via NFC.

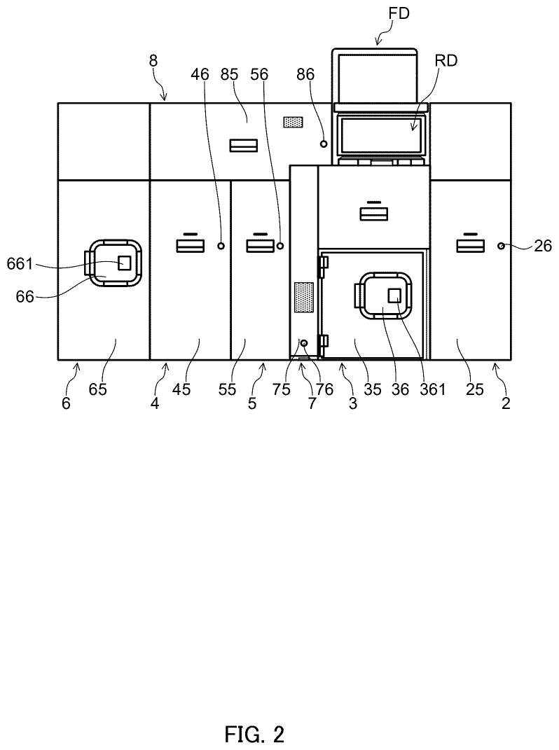

FIG. 2 is a diagram illustrating an example of an external appearance of the medium processing system 100 as viewed from the rear side. A door 25 of the rolled coin device 2, a door 35 of the banknote device 3, a door 45 of the loose coin device 4, a door 55 of the slip processing device 5, and a door 65 of the drop box 6 are provided in the rear surface of the housing 1. Through the doors 25, 35, 45, 55 and 65, the administrator of the medium processing system 100 and the like can access the inside of each device.

The doors 25, 35, 45, 55 and 65 can be locked with locks 26, 36, 46, 56 and 66. The banknote device 3 and the drop box 6 comprise key input devices 361 and 661 for inputting the personal identification number for unlocking the locks 36 and 66.

In addition, in the example illustrated in FIG. 2, a controller box 7 is provided between the banknote device 3 and the slip processing device 5. A control unit 10 described later is stored in the controller box 7. The controller box 7 comprises a door 75 and a lock 76.

A peripheral device box 8 is provided on the upper side of the banknote device 3, the loose coin device 4, and the slip processing device 5.

The main body parts of the front display FD, the pin pad PP, the card reader CaR, the code reader CoR, the receipt printer RP, the A4 printer AP, the camera Cam, and the NFC reader NM illustrated in FIG. 1 are accommodated in the peripheral device box 8. The peripheral device box 8 comprises a door 85 and a lock 86.

In addition, a rear display RD is provided on the upper side of the banknote device 3 in the rear surface of the housing 1. The rear display RD is a display unit, and is also an input unit. As with the front display FD, the rear display RD has a structure (touch panel) in which a touch pad and a flat-screen display are superimposed. The rear display RD can perform various kinds of display for the administrator and receive input operations of the administrator.

### Configuration of Slip Processing Device 5

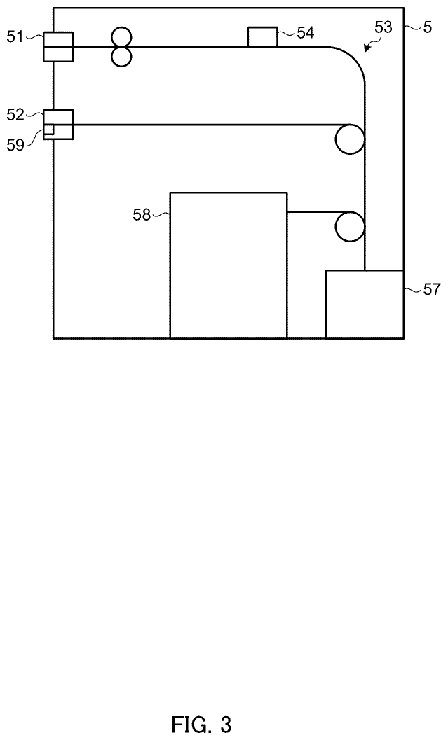

Next, as an example of the internal structure of each device provided in the medium processing system 100, an internal structure of the slip processing device 5 is described. FIG. 3 is a diagram schematically illustrating an example of an internal structure of the slip processing device 5. As illustrated in FIG. 3, the slip processing device 5 comprises the receiving port 51, the return port 52, a transport unit 53, a recognition unit 54, a temporary storage unit 57, a storage unit 58, and a removal sensor 59.

The transport unit 53 transports deposit slips or checks between the receiving port 51, the return port 52, the temporary storage unit 57, and the storage unit 58. The transport unit 53 is composed of a belt and a roller, for example. A deposit slip or a check fed from the receiving port 51 and recognized to be receivable at the recognition unit 54 is transported by the transport unit 53 to the temporary storage unit 57.

In addition, the transport unit 53 transports to the return port 52 the deposit slip or check that is recognized by the recognition unit 54 to be not receivable.

The recognition unit 54 is disposed between the receiving port 51 and the temporary storage unit 57 on the path of the transport unit 53. The recognition unit 54 recognizes the recognition information described on the deposit slip and check fed from the receiving port 51. More specifically, the recognition unit 54 comprises a magnetic ink character reader (MICR), and reads the recognition information described on a deposit slip and a check at a predetermined position.

The recognition information is information for specifying the user or the account related to the user such as the user ID or account number, or information for specifying the deposit process. The recognition information is letter information using magnetic ink that can be read by the MICR (hereinafter referred to as “MICR letters” as necessary), for example.

The recognition unit 54 comprises a contact image sensor (CIS) in addition to the MICR. The CIS acquires the image of a deposit slip and a check, and determines the recognition information from the acquired image.

The temporary storage unit 57 temporarily stores the deposit slip and check. The deposit slip and check stored in the temporary storage unit 57 are transported to any of the transport unit 53, the return port 52 or the storage unit 58. The storage unit 58 stores the deposit slip and check transported from the temporary storage unit 57 in a mixed manner.

The removal sensor 59 is disposed in the vicinity of the return port 52. The removal sensor 59 may be an optical sensor that detects the presence of the deposit slip or check at the return port 52, for example. The removal sensor 59 detects a fact that the returned deposit slip or check is pulled out by the user from the return port 52. By detecting the output signal of the removal sensor 59, the slip processing device 5 or the control unit 10 determines whether the deposit slip or check transported to the return port 52 has been removed.

Note that, the rolled coin device 2, the banknote device 3, and the loose coin device 4 have an internal structure identical or similar to that of the above-described slip processing device 5, or have a known internal structure. Therefore, the description of the internal structure is omitted for the rolled coin device 2, the banknote device 3, and the loose coin device 4.

### Configuration of Drop Box 6

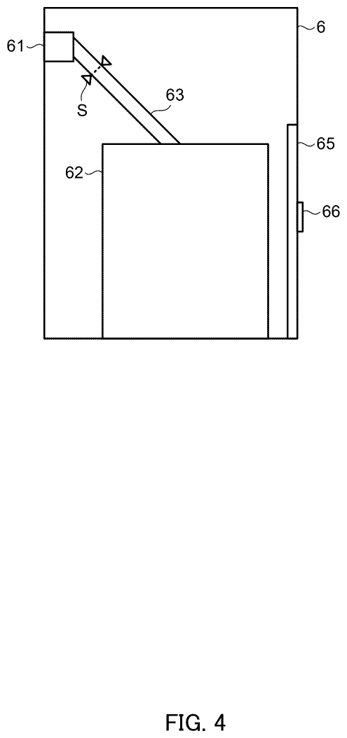

FIG. 4 is a diagram schematically illustrating an example of an internal structure of the drop box 6. As illustrated in FIG. 4, the drop box 6 comprises the receiving port 61, a storage unit 62, a chute 63, the door 65, and a lock 66.

The storage unit 62 stores an envelope containing a rejected medium and a deposit slip. The storage unit 62 is disposed below the receiving port 61, and stores the envelope inserted to the receiving port 61 through the chute 63. When the door 65 is opened by the administrator in the state where the lock 66 is unlocked, and the storage unit 62 is pulled out, the envelope stored inside the storage unit 62 is taken out.

The chute 63 transports the envelope between the receiving port 61 and the storage unit 62. The chute 63 is formed in a plate form such that the envelope slides downward from the receiving port 61 toward the storage unit 62. The envelope inserted from the receiving port 61 is transported to the storage unit 62 via the chute 63.

In addition, on the receiving port 61 side of the chute 63, an insertion sensor S that detects the insertion of an envelope containing a deposit slip and a rejected medium may be provided. In this case, the drop box 6 determines the presence/absence of the insertion of the envelope by detecting the output signal of the insertion sensor S. The insertion sensor S may be an image sensor, for example. The image sensor reads at least one of the size, shape, color, written letters, and diagram of the inserted medium. The control unit 10 specifies the type of the inserted medium on the basis of the read information. The control unit 10 determines that the medium of the specified type has been inserted. Alternatively, the insertion sensor S may be an optical sensor that detects passage of the inserted medium. The control unit 10 may determine that a rejected medium is inserted when the optical sensor detects passage of some medium during a time period in which the insertion of the rejected medium is expected, for example.

### Configuration of Control Unit 10

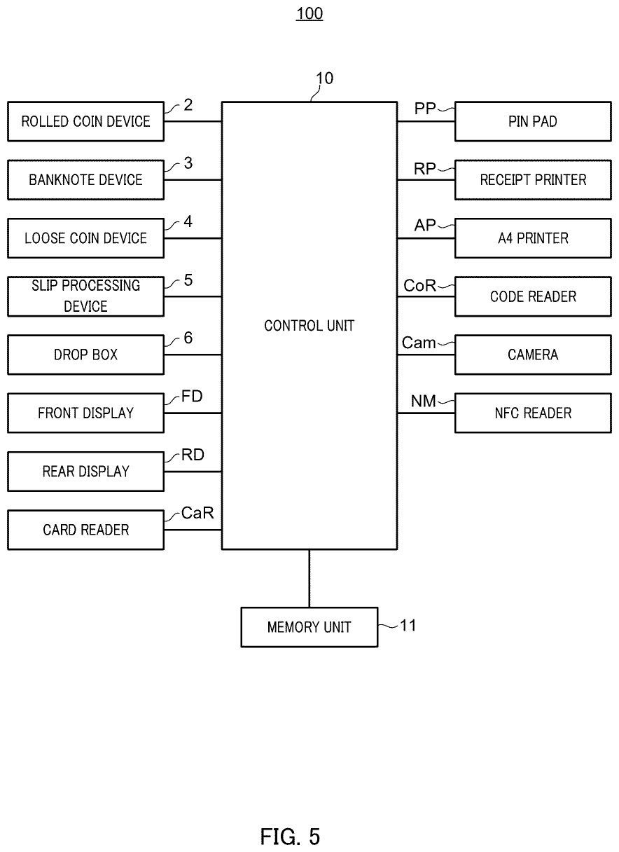

FIG. 5 is a block diagram illustrating an example of a functional block of the medium processing system 100. The control unit 10 is a processor that controls each component provided in the medium processing system 100. Each unit of the medium processing system 100, and a memory unit 11 are connected to the control unit 10. The memory unit 11 is a storage device such as a memory that stores various data, programs and the like required for the process executed by the control unit 10.

### Hardware Configuration of Medium Processing System 100

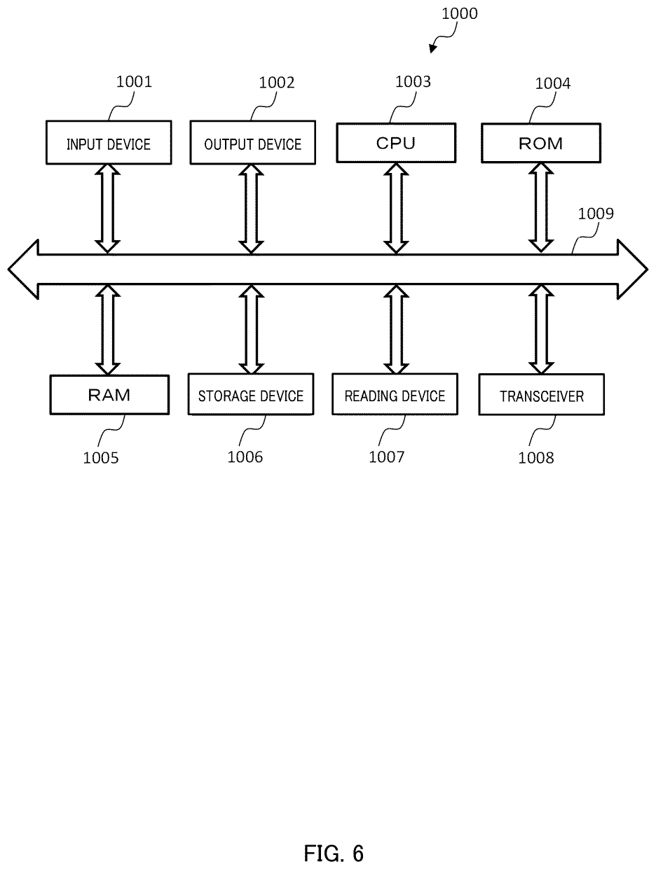

FIG. 6 is a diagram illustrating an example of a hardware configuration of the medium processing system 100 serving as a computer.

A computer 1000 comprises an input device 1001, an output device 1002, a CPU 1003, a read only memory (ROM) 1004, a random access memory (RAM) 1005, a storage device 1006, a reading device 1007 that reads information from various recording medium, and a transceiver 1008, and each unit are connected through a bus 1009.

The front display FD and the pin pad PP illustrated in FIG. 1 and the like, and the rear display RD illustrated in FIG. 2 and the like are examples of the input device 1001. The front display FD and the rear display RD are examples of the output device 1002. The memory unit 11 illustrated in FIG. 5 is an example of the storage device 1006.

From a recording medium storing a program for implementing the functions the above-described devices, the reading device 1007 reads the program, and stores it in the storage device 1006. Alternatively, the transceiver 1008 stores in the storage device 1006 a program downloaded from a system device connected to a network by communicating with the system device.

Then, when the CPU 1003 copies a program stored in the storage device 1006 to the RAM 1005, sequentially reads an order included in that program from the RAM 1005 and executes the order, each functional block of the medium processing system 100 illustrated in FIG. 5 operates.

### Operation of Medium Processing System 100

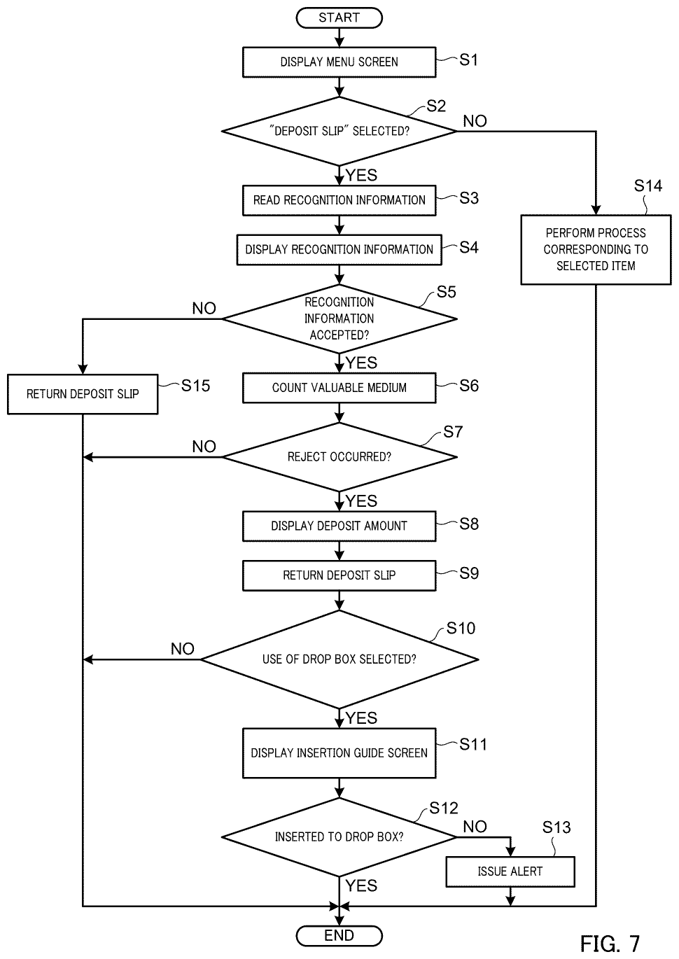

Next, an example of the medium processing performed by the medium processing system 100 is described. FIG. 7 is a flowchart illustrating an example of a procedure of a deposit transaction performed by the medium processing system 100 when reject occurs.

First, at step S1, when performing a deposit transaction, the control unit 10 displays an identification screen on the front display FD. The identification screen is a screen for performing identification of the user by inputting the user information when service such as a deposit transaction using the medium processing system 100 is performed.

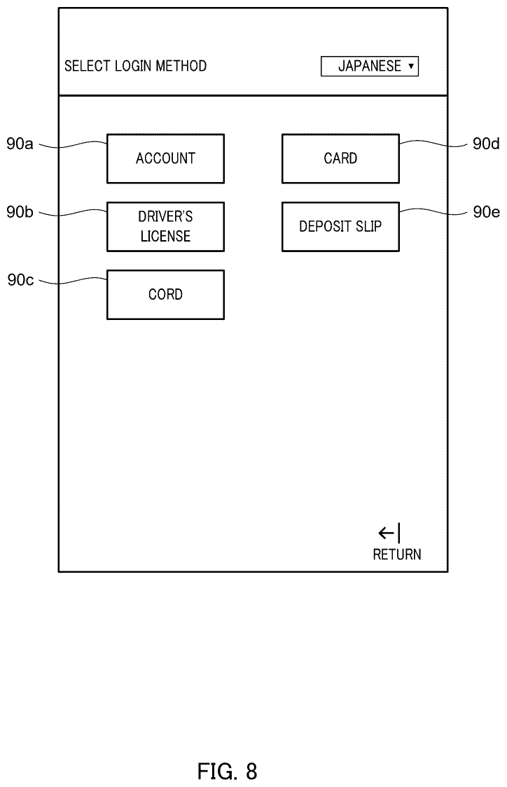

FIG. 8 is a schematic view for describing an identification screen. As illustrated in FIG. 8, a plurality of selection buttons 90a to 90e that is selected to perform user identification is displayed on the identification screen.

A selection button 90a represented by the item name “account” is selected to perform identification using a preliminarily set user ID (identification), password and the like. A selection button 90b represented by the item name “driver's license” is selected to perform identification using a driver's license.

A selection button 90c represented by the item name “code” is selected to perform identification using a QR code (registered trademark), a PIN and the like. A selection button 90d represented by the item name “card” is selected to perform identification using a card such as a credit card with which the user can be recognized.

A selection button 90e represented by the item name “deposit slip” is selected to perform identification using a deposit slip. In the present embodiment, when user identification is to be performed, the selection button 90e for performing deposit slip identification is selected.

Returning to description with reference to FIG. 7, at step S2, the control unit 10 determines whether the selection button 90e representing deposit slip identification has been selected among the selection buttons 90a to 90e displayed on the menu screen. When any of the selection buttons 90a to 90d has been selected (step S2: NO), the process corresponding to the selected item is performed at step S14, and the series of processes is terminated.

On the other hand, when the selection button 90e has been selected (step S2: YES), the slip processing device 5 recognizes, by the recognition unit 54, the recognition information on the deposit slip inserted to the receiving port 51 at step S3. More specifically, the recognition unit 54 detects the recognition information by recognizing the letters written on the deposit slip in MICR letters. Then, the recognition unit 54 supplies, to the control unit 10, the recognized recognition information of the deposit slip.

At this time, the deposit slip whose recognition information has been recognized is transported to the temporary storage unit 57, and is temporarily stored. Here, the control unit 10 may return the deposit slip whose recognition information could not be recognized to the user by transporting it to the return port 52, and terminate the series of processes.

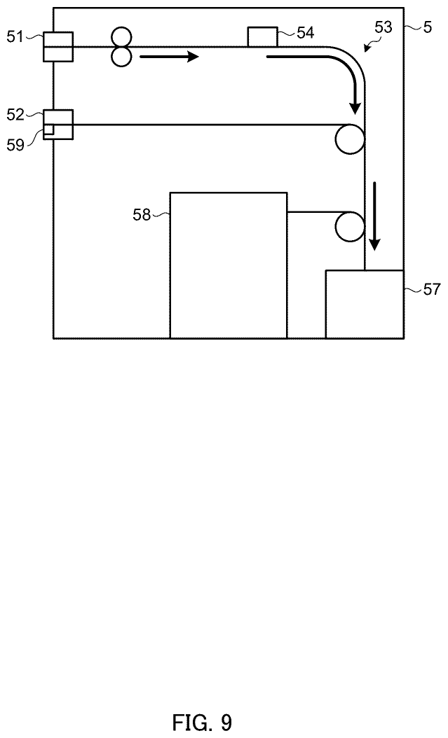

FIG. 9 is a schematic view for describing a transport path when a deposit slip is stored in the temporary storage unit 57. In FIG. 9, the arrow indicates a transport path of the deposit slip to be stored in the temporary storage unit 57. As illustrated in FIG. 9, the deposit slip inserted to the slip processing device 5 is carried through the recognition unit 54 from the receiving port 51 by means of the transport unit 53, and is stored in the temporary storage unit 57.

Returning to description with reference to FIG. 7, at step S4, the control unit 10 displays on the front display FD the content of the recognition information read from the deposit slip. In this case, the front display FD displays the user ID, the account number or the like, for example.

At step S5, the control unit 10 determines whether the content displayed on the front display FD has been accepted by the user. When the displayed content has been accepted by the user (step S5: YES), the process is advanced to step S6. When the display content has not been accepted by the user (step S5: NO), the control unit 10 at step S15 transports the deposit slip to the return port 52 to return it to the user, and terminates the series of processes. At step S6, the control unit 10 sets the medium processing device to a state where the medium is receivable, and receives and counts the valuable medium inserted to the medium processing device by the user. When a rejected medium is generated, the medium processing device executes a return process of returning the rejected medium.

At step S7, the control unit 10 determines whether a rejected medium has been generated as a result of the count. When a rejected medium has been generated (step S7: YES), the process is advanced to step S8. On the other hand, at step S7, when no rejected medium has been generated (step S7: NO), the series of processes is terminated. At this time, the deposit slip is transported from the temporary storage unit 57 to the storage unit 58, and stored. In addition, when no rejected medium has been generated (step S7: NO), the control unit 10 may display a deposit amount, which is a count result, on the front display FD, and terminate the series of processes on condition that the user's acceptance has been input.

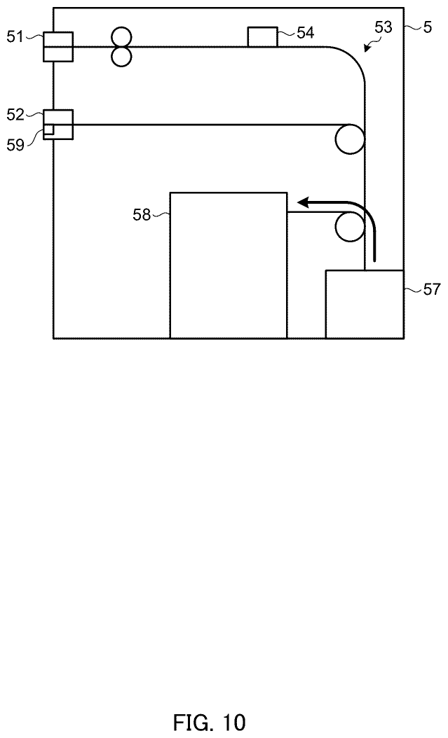

FIG. 10 is a schematic view for describing a transport path when a deposit slip is stored in the storage unit 58. In FIG. 10, the arrow indicates a transport path of the deposit slip to be stored into the storage unit 58. As illustrated in FIG. 10, deposit slip stored in the temporary storage unit 57 is stored into the storage unit 58 by the transport unit 53.

Returning to description with reference to FIG. 7, at step S8, the control unit 10 displays on the front display FD the deposit amount as a count result. In this case, the front display FD displays the number of valuable media for each denomination, for example. In addition, the front display FD displays an indication for the user to select whether to deposit the rejected medium using the drop box 6.

At this time, the front display FD may display a screen for the user to input the type and number of rejected media, or the total amount of rejected media. Here, even when the rejected medium has not been normally recognized by the medium processing device, the number of rejected media may have been counted. In addition, for the rejected media that could have been normally recognized by the medium processing device but have been returned because the storage unit of the medium processing device has been full, the type and number of rejected media or the total amount of rejected media have been counted.

At step S9, the control unit 10 returns the deposit slip stored in the temporary storage unit 57. At this time, the slip processing device 5 determines whether the deposit slip has been pulled out by means of the removal sensor 59. Note that, when returning the deposit slip, the control unit 10 may add second information indicating that the return process has been completed on the back of the deposit slip or the like. More specifically, information indicating the date and time of the return process may be printed. In addition, information related to the type and number of rejected media or the total amount of rejected media may be printed.

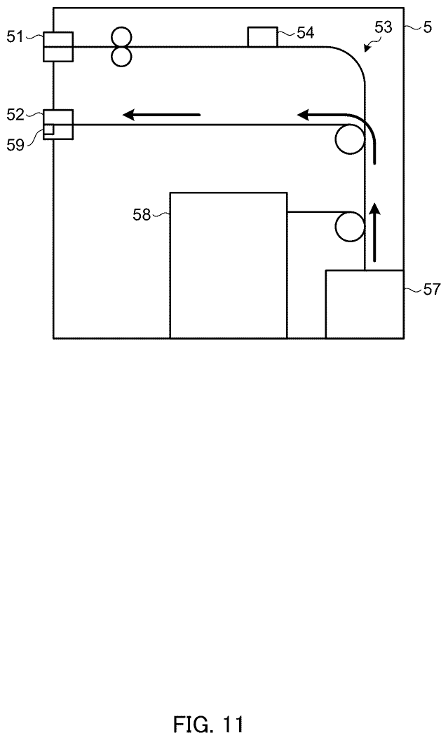

FIG. 11 is a schematic view for describing a transport path when a deposit slip is returned. In FIG. 11, the arrow indicates a transport path of a returned deposit slip. As illustrated in FIG. 11, the deposit slip stored in the temporary storage unit 57 is transported by the transport unit 53 to the return port 52.

Returning to description with reference to FIG. 7, at step S10, the control unit 10 determines whether the use of the drop box 6 has been selected on the basis of the input of the user regarding the able/disable of the use of the drop box 6 displayed at step S8. When the control unit 10 determines that the use of the drop box 6 has been selected (step S10: YES), the process is advanced to step S11. On the other hand, when the control unit 10 determines that the use of the drop box 6 has not been selected (step S10: NO), the series of processes is terminated.

At step S11, the control unit 10 displays on the front display FD a screen to induce insertion of a rejected medium to the drop box 6. In this manner, the user is guided to insert the returned deposit slip and rejected medium to the drop box 6. At this time, the user inserts to the drop box 6 the returned deposit slip and rejected medium in a paired manner. More specifically, the user inserts the returned deposit slip and rejected medium into an envelope, and inserts the envelope to the drop box 6.

At step S12, the control unit 10 determines whether the envelope containing the deposit slip and the rejected medium has been inserted to the drop box 6. When the insertion sensor S of the drop box 6 detects that the envelope has been inserted to the drop box 6, (step S12: YES), the series of processes is terminated.

On the other hand, when the envelope has not been inserted to the drop box 6 (step S12: NO), the process is advanced to step S13. At step S13, the control unit 10 notifies an alert indicating that the envelope has not been inserted to the drop box 6. The control unit 10 may determine that the envelope has not been inserted to the drop box 6 when the insertion sensor S of the drop box 6 does not detect the insertion of the envelope into the drop box 6 even after an elapse of a predetermined time after the selection of the use of the drop box 6.

Here, for example, there may be a case where the user forgets to remove the returned deposit slip, and the envelope is inserted to the drop box 6 with only the rejected medium enclosed. In this case, the envelope inserted to the drop box 6 does not have information that specifies the user or account. Therefore, the administrator of the medium processing system 100 cannot perform the deposit transaction for the rejected medium inserted to the drop box 6.

In view of this, in the present embodiment, the control unit 10 may issue alert regarding the omission of enclosing the deposit slip in the envelope on the basis of the detection result of the insertion sensor S of the drop box 6 and the removal sensor 59 of the slip processing device 5.

Specifically, for example, when the insertion of an envelope is detected by the insertion sensor S and the removal sensor 59 detects that the deposit slip has not been removed, the control unit 10 notifies an alert such as calling an administrator. In this manner, the administrator is notified that an envelope without the deposit slip has been inserted to the drop box 6, thereby enabling a prompt response to the deposit transaction involving the rejected medium.

Note that, after the series of processes illustrated in FIG. 7 has been completed, the medium processing system 100 communicates with an external server that manages the account, and performs a deposit process of reflecting on the user's account the deposit amount counted by the medium processing device. In addition, the administrator of the medium processing system 100 confirms the rejected medium inserted to the drop box 6, and performs the deposit process of reflecting the total amount of rejected media on the user's account by using a terminal that communicates with the external server that manages the account.

As described above, in the medium processing system 100 according to the present embodiment, when a return process of returning the rejected medium occurs, the deposit slip is returned from the slip processing device 5. In this manner, when the deposit transaction involving the rejected medium is performed, it is no longer necessary to manually input recognition information for specifying the user or account, or to print a receipt. Therefore, the processing for depositing the rejected medium can be performed more easily.

In addition, the above-described medium processing system 100 further comprises the drop box 6 into which the returned deposit slip and rejected medium are inserted in a paired manner. In this manner, the deposit slip provided with the recognition information is inserted together with the rejected medium, and thus the deposit process of the rejected medium can be easily performed.

In addition, in the above-described medium processing system 100, when the return process occurs, the user is prompted to select whether to deposit the rejected medium using the drop box 6. As a result, the user can select how to handle the rejected medium, such as whether to take it back or deposit it.

In addition, in the above-described medium processing system 100, when the deposit of the rejected medium using the drop box 6 is selected, the user is instructed to insert the deposit slip and rejected medium into the drop box 6. In this manner, it is possible to prevent the user from forgetting to deposit the rejected medium.

In addition, in the above-described medium processing system 100, an indication to induce insertion of the deposit slip and rejected medium into the drop box 6 is displayed. In this manner, the user can be reliably instructed to deposit the rejected medium.

In addition, in the above-described medium processing system 100, the drop box 6 comprises the receiving port 61 for receiving the deposit slip and rejected medium, and the shutter provided at the receiving port 61. In this manner, it is possible to prevent items from being mistakenly inserted to the drop box 6.

In addition, in the above-described medium processing system 100, when the rejected medium is deposited using the drop box 6, the shutter is unlocked. In this manner, it is possible to prevent items from being mistakenly inserted to the drop box 6.

In addition, in the above-described medium processing system 100, the drop box 6 comprises the insertion sensor that detects the insertion of the deposit slip and rejected medium. In this manner, when the rejected medium is deposited, the insertion to the drop box 6 can be reliably detected.

In addition, in the above-described medium processing system 100, when the deposit slip and rejected medium are not inserted to the drop box 6, a notification is issued indicating that they have not been inserted. In this manner, it is possible to prevent the deposit of the rejected medium from being forgotten.

In addition, in the above-described medium processing system 100, the slip processing device 5 comprises the removal sensor 59 that detects removal of the returned deposit slip when the return process occurs. Further, when insertion of the rejected medium to the drop box 6 is detected, and omission of removal of the deposit slip is detected, a notification that the deposit slip corresponding to the rejected medium has not been inserted to the drop box 6 is issued. In this manner, the administrator is notified that an envelope without the deposit slip has been inserted to the drop box 6, thereby enabling a prompt response to the deposit process of the rejected medium.

In addition, in the above-described medium processing system 100, the slip processing device 5 comprises the recognition unit 54 that recognizes first information, added to the deposit slip, that specifies the user or the account related to the user, or the deposit transaction. Further, when the first information is normally recognized, the deposit process of the valuable medium is performed. In this manner, on the basis of the information added to the deposit slip, the deposit process of the valuable medium can be reliably performed.

In addition, in the above-described medium processing system 100, when the return process occurs, at least one of the type and the number of rejected media is displayed. In this manner, information about the occurrence of the return process and the rejected medium can be notified to the user.

In addition, in the above-described medium processing system 100, when the return process occurs, the user is prompted to input information related to the type and the number of rejected media, or the total amount of rejected media. In this manner, the user can reliably determine the type and the number of rejected media.

In addition, in the above-described medium processing system 100, when the return process occurs, the slip processing device 5 adds second information indicating that return process has been performed to the deposit slip. In this manner, it becomes clear that the returned deposit slip has been returned due to the occurrence of the return process.

In addition, in the above-described medium processing system 100, the slip processing device 5 comprises the temporary storage unit 57 that temporarily stores the received deposit slip. In this manner, it is possible to prevent the deposit slip from being stored before the occurrence of the return process.

In addition, in the above-described medium processing system 100, the slip processing device 5 further comprises the storage unit 58 that stores the deposit slip stored in the temporary storage unit 57 when the return process does not occur. In this manner, deposit slips for completed deposit transactions and deposit slips for incomplete deposit transactions can be handled separately.

In addition, in the above-described medium processing system 100, the slip processing device 5 further comprises the return port 52 for returning the deposit slip stored in the temporary storage unit 57 when the return process occurs. In this manner, the rejected medium can be deposited using the returned deposit slip.

It should be noted that the present disclosure is not limited to the above embodiment, and various modifications may be made without departing from the gist of the present disclosure. In particular, the plurality of embodiments and modified examples described in this specification may be combined with each other as necessary.

This application is entitled to and claims the benefit of Japanese Patent Application No. 2023-042740 filed on Mar. 17, 2023, the disclosure each of which including the specification, drawings and abstract is incorporated herein by reference in its entirety.

What is claimed is:

1. A medium processing system comprising:
a medium processing device that receives a valuable medium inserted by a user in a deposit transaction;
a slip processing device that receives a deposit slip inserted by the user; and
a control circuitry that causes the slip processing device to return the deposit slip when a return process of returning a rejected medium occurs, the rejected medium being a valuable medium that is not depositable in the medium processing device.

2. The medium processing system according to claim 1, further comprising a drop box to which the deposit slip and the rejected medium that are returned are inserted in a paired manner.

3. The medium processing system according to claim 2, wherein the control circuitry receives an input regarding whether to deposit the rejected medium using the drop box when the return process occurs.

4. The medium processing system according to claim 3, wherein when an input to deposit the rejected medium using the drop box is received, the control circuitry notifies the user with an instruction to insert the deposit slip and the rejected medium to the drop box.

5. The medium processing system according to claim 3, further comprising a display,
wherein the control circuitry causes the display to display an indication to induce insertion of the deposit slip and the rejected medium to the drop box.

6. The medium processing system according to claim 2, wherein the drop box further comprises:
a receiving port that receives the deposit slip and the rejected medium inserted by the user; and
a shutter disposed at the receiving port.

7. The medium processing system according to claim 6, wherein the control circuitry causes the shutter to unlock when the input to deposit the rejected medium using the drop box is received.

8. The medium processing system according to claim 2, wherein the drop box comprises an insertion sensor that detects insertion of the deposit slip and the rejected medium.

9. The medium processing system according to claim 8, wherein when the deposit slip and the rejected medium are not inserted to the drop box, the control circuitry notifies that the deposit slip and the rejected medium are not inserted based on a signal of the insertion sensor.

10. The medium processing system according to claim 8,
wherein the slip processing device comprises a removal sensor that detects removal of the deposit slip that is returned when the return process occurs, and
wherein when the insertion sensor detects insertion of the rejected medium to the drop box, and the removal sensor detects omission of removal of the deposit slip, the control circuitry notifies that the deposit slip corresponding to the rejected medium inserted to the drop box is not inserted.

11. The medium processing system according to claim 1,
wherein the deposit slip comprises first information that specifies the user or an account related to the user, or the deposit transaction,
wherein the slip processing device comprises a recognition sensor that recognizes the first information, and
wherein the control circuitry causes the medium processing device to receive the valuable medium when the first information is normally recognized by the recognition sensor.

12. The medium processing system according to claim 1, wherein when the return process occurs, the control circuitry notifies at least one of a type and a number of rejected media.

13. The medium processing system according to claim 1, wherein when the return process occurs, the control circuitry receives input of the user regarding the type and the number of rejected media, or a total amount of rejected media.

14. The medium processing system according to claim 1, wherein when the return process occurs, the slip processing device adds, to the deposit slip, second information indicating that the return process is performed.

15. The medium processing system according to claim 1, wherein the slip processing device comprises a temporary storage that temporarily stores the deposit slip received.

16. The medium processing system according to claim 15, wherein the slip processing device further comprises a storage that stores the deposit slip stored in the temporary storage when the return process does not occur.

17. The medium processing system according to claim 15, wherein the slip processing device further comprises a return port for returning the deposit slip stored in the temporary storage when the return process occurs.

18. A medium processing method comprising:
receiving a deposit slip inserted by a user in a deposit transaction;
receiving a valuable medium inserted by the user; and
returning the deposit slip when a return process of returning a rejected medium occurs, the rejected medium being a valuable medium that is not depositable.

19. A non-transitory computer-readable storage medium comprising executable instructions; wherein
the executable instructions when executed by a processor from the non-transitory computer-readable storage medium cause the processor to perform operations comprising:
receiving a deposit slip inserted by a user in a deposit transaction;
receiving a valuable medium inserted by the user, and
returning the deposit slip when a return process of returning a rejected medium occurs, the rejected medium being a valuable medium that is not depositable.
